(19) United States
(12) Patent Application Publication
(10) Pub. No.: US 2011/0282686 A1
(43) Pub. Date: Nov. 17, 2011

(54) MEDICAL CONFERENCING SYSTEMS AND METHODS

(75) Inventors: Medhi Venon, Whitefish Bay, WI (US); Neal Nachtigall, Sioux Falls, SD (US)

(73) Assignee: General Electric Company, Schenectady, NY (US)

(21) Appl. No.: 12/778,794

(22) Filed: May 12, 2010

(51) Int. Cl. G06Q 50/00; G06F 3/01; G06F 3/048

(52) U.S. Cl. 705/3; 715/753; 715/763

(57) ABSTRACT

Medical conferencing systems and methods are described. An example medical conferencing system includes an access device and a mobile device. The mobile device includes a first data storage to store data including a shared image received from the access device. Additionally, the mobile device includes a first user interface to display the shared image for user viewing, manipulation, annotation, and measuring. The manipulation enabling the shared image to be displayed at the mobile device with different viewing parameters than at the access device. Additionally, the mobile device includes a first processor to receive input via the first user interface and provide content, including the shared image to the first user interface, the processor to receive input via the access device and provide content to the first user interface, the processor to convey input received via the first user interface to the access device.

### FIELD OF THE DISCLOSURE

The present disclosure relates generally to healthcare information systems and, more particularly, to medical conferencing systems and methods.

### BACKGROUND

Healthcare environments, such as hospitals or clinics, include information systems, such as hospital information systems (HIS), radiology information systems (RIS), clinical information systems (CIS), and cardiovascular information systems (CVIS), and storage systems, such as picture archiving and communication systems (PACS), library information systems (LIS), healthcare information exchanges (HIE) that provide access to, for example, information portals for affiliated practitioners and/or patients, and electronic medical records (EMR). Information stored may include patient medical histories, imaging data, imaging reports, quantitative and qualitative imaging results, test results, diagnosis information, management information, and/or scheduling information, for example. The information may be centrally stored or divided at a plurality of locations. Healthcare practitioners may desire to access patient information or other information at various points in a healthcare workflow. For example, during and/or after surgery, medical personnel may access patient information, such as images of a patient's anatomy, that are stored in a medical information system. Radiologist and/or other clinicians may review stored images and/or other information, for example. In some examples, radiologists may collaborate with colleagues or other individuals to obtain a second opinion regarding a particular image or images. Traditionally such collaboration would occur as colleagues viewed images on the same device and physically highlighted items of interest and discussed observations. In today's virtual and distributed healthcare environment, collaborating at the same device may not be possible as colleagues are less likely to be co-located and require alternative methods to bring the same value to patient care.

### SUMMARY

An example method of conferencing including sharing medical images and information between a first access device and a second access device includes enabling a first user associated with the first access device to request a conference with a second user associated with the second access device. The method includes determining acceptance by the second user of the conference and enabling the conference to be initiated between the first access device and the second access device. The method includes enabling the first user to select at least one image to be displayed at the second access device and displaying a first view of the image and a second view of the image at the first access device. The method includes displaying the second view of the image at second access device and enabling the first access device to retain control over the first view of the image. The method includes enabling the first user at the first access device and the second user at the second access device to substantially simultaneously add content to the second view of the image.

An example method of sharing digital radiology images between a workstation and a mobile device includes enabling a first user associated with the workstation to request a conference with a second user associated with the mobile device. The method includes determining acceptance by the second user of the conference and enabling the conference to be initiated between the workstation and the mobile device. The method includes enabling the first user to select at least one image to be shared with the second user and displaying a first view of the image and a second view of the image at the workstation. The method includes displaying the second view of the image at the mobile device. The method includes enabling the second view of the image at the workstation to comprise first viewing parameters and the second view of the image at the mobile device to comprise second viewing parameters different than the first viewing parameters. The method includes enabling the first user at the workstation and the second user at the mobile device to add content to the second view of the image.

An example medical conferencing system includes an access device and a mobile device. The mobile device includes a first data storage to store data including a shared image received from the access device. Additionally, the mobile device includes a first user interface to display the shared image for user viewing, manipulation, annotation, and measuring. The manipulation enabling the shared image to be displayed at the mobile device with different viewing parameters than at the access device. Additionally, the mobile device includes a first processor to receive input via the first user interface and provide content, including the shared image to the first user interface, the processor to receive input via the access device and provide content to the first user interface, the processor to convey input received via the first user interface to the access device.

### BRIEF DESCRIPTION OF THE DRAWINGS

FIG. 1 illustrates an example conferencing system.

FIG. 2 illustrates example access devices that can be used to implement the example conferencing system of FIG. 1.

FIGS. 3-7 depict an example conferencing workflow using a plurality of example access devices.

FIG. 8 depicts another conferencing workflow using a plurality of example access devices.

FIG. 9 depicts another conferencing workflow using a plurality of example access devices.

FIG. 10 depicts another conferencing workflow using a plurality of example access devices.

FIG. 11 is a flow diagram representative of example machine readable instructions that may be executed to implement example components of the examples described herein.

FIG. 12 is a schematic illustration of an example processor platform that may be used and/or programmed to implement any or all of the example methods and systems described herein.

The foregoing summary, as well as the following detailed description of certain implementations of the methods, apparatus, systems, and/or articles of manufacture described herein, will be better understood when read in conjunction with the appended drawings. It should be understood, however, that the methods, apparatus, systems, and/or articles of manufacture described herein are not limited to the arrangements and instrumentality shown in the attached drawings.

### DETAILED DESCRIPTION

Although the following discloses example methods, apparatus, systems, and articles of manufacture including, among other components, firmware and/or software executed on hardware, it should be noted that such methods, apparatus, systems, and/or articles of manufacture are merely illustrative and should not be considered as limiting. For example, it is contemplated that any or all of these firmware, hardware, and/or software components could be embodied exclusively in hardware, exclusively in software, exclusively in firmware, or in any combination of hardware, software, and/or firmware. Accordingly, while the following describes example methods, apparatus, systems, and/or articles of manufacture, the examples provided are not the only way(s) to implement such methods, apparatus, systems, and/or articles of manufacture.

When any of the appended claims are read to cover a purely software and/or firmware implementation, at least one of the elements in at least one example is hereby expressly defined to include a tangible medium such as a memory, DVD, CD, ect. storing the software and/or firmware.

The examples described herein relate to conferencing systems and methods that enable findings to be quickly confirmed and consultation to be quickly obtained during a workflow and, thus, to improve workflow efficiency. The examples described herein enable users to perform parallel readings on an image while maintaining the ability to manipulate the image at respective access devices. The examples described herein enable users to utilize tools of access devices to perform advanced processing, manipulation, qualitative and/or quantitative annotation(s), dictation, editing and/or measuring, etc. on an image that can be dynamically shared with others. The examples described herein enable, during a conferencing session, an image at a workstation to have different viewing parameters than the image at a mobile device. The examples described herein enable, during a conferencing session, content to be substantially simultaneously added to an image by a first user at a workstation and by a second user at a mobile device.

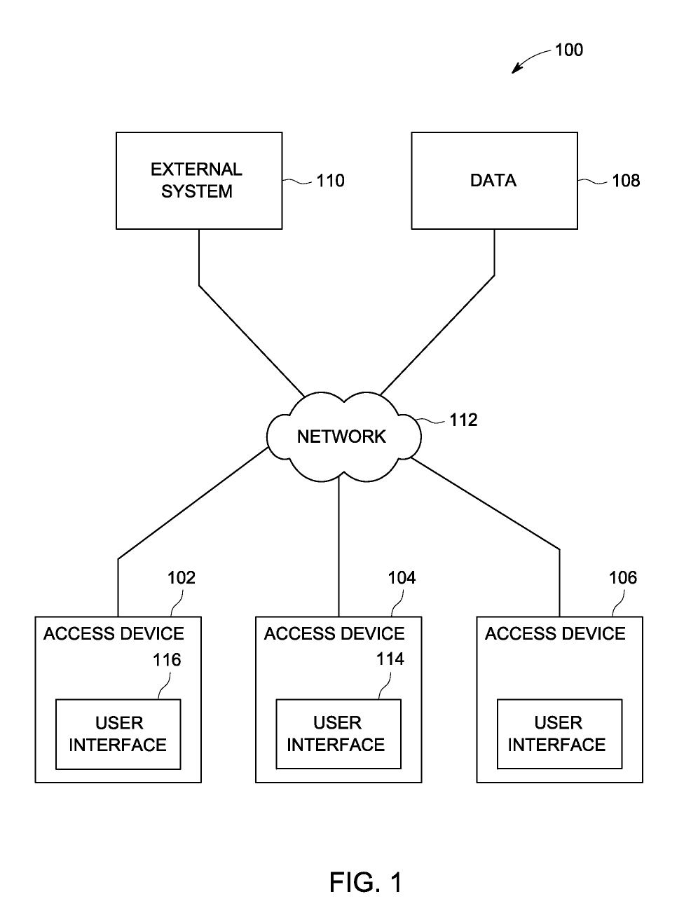

FIG. 1 depicts an example medical conferencing or image sharing system 100 that includes a first access device 102, a second access device 104, a third access device 106, an external data source 108 and an external system 110. In some examples, the data source 108 and/or the external system 110 can be implemented in a single system. In some examples, the data source 108 and/or the external system 110 can communicate with one or more of the access devices 102-106 via a network 112. In some examples, one or more of the access devices 102-106 can communicate with the data source 108 and/or the external system 110 via the network 112. In some examples, the access devices 102-106 can communicate with one another via the network 112. The network 112 may be implemented by, for example, the Internet, an intranet, a private network, a wired or wireless Local Area Network, a wired or wireless Wide Area Network, a cellular network, and/or any other suitable network.

The data source 108 can provide images and/or other data to the access devices 102-106 for image review and/or other applications. In some examples, the data source 108 can receive information associated with a session or conference and/or other information from the access devices 102-106. In some examples, the external system 110 can receive information associated with a session or conference and/or other information from the access devices 102-106. In some examples, the external system 110 can also provide images and/or other data to the access devices 102-106. The data source 108 and/or the external system 110 can be implemented using a system such as a PACS, RIS, HIS, CVIS, EMR, archive, data warehouse, imaging modality (e.g., x-ray, CT, MR, ultrasound, nuclear imaging, etc.).

The access devices 102-106 can be implemented using a workstation (a laptop, a desktop, a tablet computer, etc.) or a mobile device, for example. Some mobile devices include smart phones (e.g., BlackBerry™, iPhone™, etc.), Mobile Internet Devices (MID), personal digital assistants, cellular phones, handheld computers, tablet computers (iPad™) etc., for example.

In practice, physicians such as radiologist may desire to collaborate with a colleague (e.g., a specialist or another radiologist) regarding an image. The colleague may not be in proximity to the same access device as the requesting radiologist. In such instances, using the examples described herein, a first user associated with the first access device 102 may collaborate with a second user associated with the second access device 104 regarding an image, for example. In contrast to some known approaches, the examples described herein enable the user requesting the session to maintain control over and to manipulate at least one view of the image while providing a second view of the image that can be manipulated by at least the reviewing user. In some examples, the examples described herein enable users to perform parallel readings of an image without impacting each others views.

To initiate a collaboration session between a first user (e.g., a requesting radiologist) and a second user (e.g., a reviewing radiologist), the first user associated with the first access device 102 may request a session or conference with a second user associated with the second access device 104. The first access device 102 may be a PACS workstation and the second access device 104 may be a mobile device; however, both the access devices may be PACS workstations or, alternatively, mobile devices, for example. Once notified, the second user may then accept or decline the request. In some examples, the second user may fulfill a security requirement for device authentication. In some examples, security standards, virtual private network access, encryption, etc., can be used to maintain a secure connection between the access devices 102 and 104.

If the second user accepts the request, the first user may then select an image to be shared with the second user. The first user may also select the view of the image initially displayed to the second user. To preserve the ability of the first user to retain the original view of the image (e.g., non-shared image), the data source 108 and/or the external system 110 may create a shared view of the image that the second user may have at least some control over. The shared image is displayed to the second user using a user interface 114 of the second access device 104. The first user may view both the shared view of the image and the original view of the image on a user interface 116 of the first access device 102.

The second user may manipulate (e.g., view the image at a different viewing parameter) the shared view of the image displayed at the second access device 104 while not affecting the shared view of the image at the first access device 102. For example, the shared view of the image at the second access device 104 may be at a different zoom factor than the shared view of the image at the first access device 102. The first user may manipulate the shared view of the image displayed at the first access device 102 while not affecting the shared view of the image at the second access device 104. In some examples, the first user can manipulate the shared view of the image displayed at the second access device 104 using the first access device 102.

The first user can edit and/or add content (e.g., draw shapes or objects and annotate to generate measurements, highlight abnormal structure, and/or add textual comments) and/or identify a finding on the shared view of the image at the first access device 102. These edits may be conveyed to the shared view of the image at the second access device 104 and, thus, the shared view of the image at the second access device 104 can be dynamically updated. The second user can edit and/or add content (e.g., draw shapes or objects and annotate to generate measurements, highlight abnormal structure, and/or add textual comments) and/or identify findings to the shared view of the image at the second access device 104. These edits may be conveyed to the shared view of the image at the first access device 102 and, thus, the shared view of the image at the first access device 102 can be dynamically updated. Thus, the first user at the first access device 102 can add content to the shared view of the image and, at substantially the same time (e.g., substantially simultaneously), the second user at the second access device 104 can add content to the shared view of the image, for example. The display of content added at the first access device 102 on the second access device 104 and the display of content added at the second access device 104 on the first access device 102 may be limited by transmission times associated with the connection between the access devices 102 and 104, for example. For example, the first user at the first access device 102 can add content to the shared view of the image while enabling the second user at the second access device 104 to retain the ability to also add content to the shared view of the image. In some examples, the first user and/or the second user may initiate a mode in which the shared view of the image is displayed the same in both the first access device 102 and the second access device 104.

In some example, the first user can communicate with the second user via voice or text messaging (e.g., phone, SMS, e-mail services, etc.). In some examples, the second user can communicate with the first user via voice or text messaging (e.g., phone, SMS, e-mail services, etc.). In some examples, the communications between the first user and the second user may be used to generate and/or automatically incorporated into a report(s). For example, results associated with the conference may be automatically incorporated into a medical report. In some examples, the edits to the shared image and/or the identified findings may be used to generate and/or incorporated into a report(s). In some examples, the edits to the shared image and/or the identified findings may be incorporated into the original view of the image by the first user. While the above example describes the first user sharing a single image with the second user, any number of images (e.g., 1, 2, 3, etc.) may be shared instead. While the above example describes sharing an image with the second user, any other or additional information may be shared instead. For example, reports or results (e.g., lab, quantitative and/or qualitative analysis post or pre-post readings) may additionally or alternatively be shared.

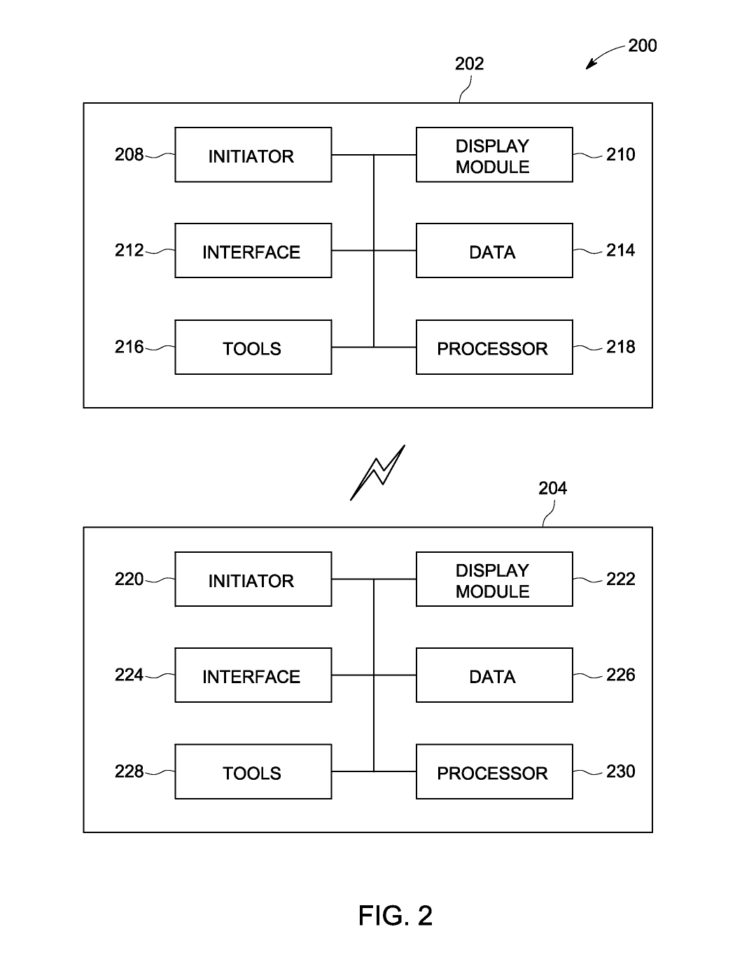

FIG. 2 is a block diagram of an example first access device 202 and an example second access device 204 of an example medical conferencing or image sharing system 200. The first access device 202 may be used to implement the first access device 102 of FIG. 1 and the second access device 204 may be used to implement the second access device 104 of FIG. 1.

The first access device 202 may include an initiator 208, a display module 210, an interface 212, a data source 214, tools 216 and a processor 218. The second access device 204 may include an initiator 220, a display module 222, an interface 224, a data source 226, tools 228 and a processor 230. While an example manner of implementing the access devices 102 and 104 of FIG. 1 have been illustrated in FIG. 2, one or more of the elements, processes and/or devices illustrated in FIG. 2 may be combined, divided, re-arranged, omitted, eliminated and/or implemented in other ways. In some examples, the processor 218 may be integrated into the initiator 208, the display module 210, the interface 212, the data source 214 and/or the tools 216. Additionally or alternatively, in some examples, the processor 230 may be integrated into the initiator 220, the display module 222, the interface 224, the data source 226 and/or the tools 228. The initiators 208 and/or 220, the display modules 210 and/or 222, the interfaces 212 and/or 224, the data sources 214 and/or 226, the tools 216 and/or 228 and/or the processors 218 and/or 230 and, more generally, the example medical conferencing system 200 may be implemented by hardware, software, firmware and/or a combination of hardware, software and/or firmware. Thus, the initiators 208 and/or 220, the display modules 210 and/or 222, the interfaces 212 and/or 224, the data sources 214 and/or 226, the tools 216 and/or 228 and/or the processors 218 and/or 230 and, more generally, the example medical conferencing system 200 can be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the initiators 208 and/or 220, the display modules 210 and/or 222, the interfaces 212 and/or 224, the data sources 214 and/or 226, the tools 216 and/or 228 and/or the processors 218 and/or 230 and, more generally, the example medical conferencing system 200 are hereby expressly defined to include a tangible medium such as a memory, DVD, CD, etc., storing the software and/or firmware. Further still, the example medical conferencing system 200 of FIG. 2 may include one or more elements, processes and/or devices in addition to, or instead of, those illustrated in FIG. 2, and/or may include more than one of any or all of the illustrated elements, processes and devices.

The access devices 202 and 204 include the processors 218 and 230 retrieving data, executing functionality and storing data at the respective access devices 202 or 204, the data source 108 (FIG. 1) and/or the external system 110 (FIG. 1). The processors 218 and 230 drive respective display modules 210 and 222 and interfaces 212 and 224 providing information and functionality to a user input to control the access devices 202 and 204, edit information, etc. In some examples, the interfaces 212 and/or 224 may be configured as a graphical user interface (GUI). The GUI may be a touch pad/screen integrated with and/or attached to the respective access devices 202 or 204. In some examples, the interfaces 212 and/or 224 may be a keyboard, mouse, track ball, microphone, etc. In some examples, the interfaces 212 and/or 224 may include an accelerometer and/or global positioning sensor and/or other positional/motion indicator to enable a user to change the view of the image displayed at the respective display module 210 and 222.

The access devices 202 and 204 include one or more internal memories and/or data stores including the data sources 214 and 226 and the tools 216 and 228. Data storage can include any variety of internal and/or external memory, disk, remote storage communicating with the access devices 202 and 204.

The processor 218 and/or 230 can include and/or communicate with a communication interface component to query, retrieve, and/or transmit data to and/or from the first access device 202 and the second access device 204 and/or the data source 108 (FIG. 1) and/or the external system 110 (FIG. 1), for example. Using user input received via the interface 224 as well as information and/or functionality from the data sources 226 and the tools 228, the processor 230 can convey an annotation to a shared view of an image at the second access device 204 to the first access device 202, for example.

In operation, a first user associated with the first access device 202 may request a session or conference with a second user associated with the second access device 204 using the initiator 208. In some examples, the second user may be selected from a plurality of other users (e.g., colleagues, specialists, other radiologists, etc.) that the first user knows or are part of a collaborating conferencing group and/or associated with a healthcare group. The request may be conveyed, via the processor 218, to the second access device 204 where the request may be displayed on the display module 222, for example. The second user may then accept or decline the request using the interface 224. The acceptance or denial may be conveyed from the second access device 204 to the first access device 202 using the processor 230, for example.

If the second user accepts the request, the first user may select an image (e.g., X-ray, digital radiology image, CT scan, MRI, Ultrasound, etc.) to be shared with the second user using the interface 212. The image(s) may be stored in the data source 214 and/or 108. The first user may also select the view of the image initially displayed to the second user. Alternatively, the second access device 204 may include pre-set preferences of the view that the second user prefers. In other examples, the first user may select a plurality of images to be shared with the second user using the interface 212. In such examples, the first user may select the image and the view of that image to be initially displayed to the second user.

The shared view of the image (e.g., the image(s) and optionally including associated data) is then conveyed to the second access device 204, via the processor 218, and is displayed using the display module 222. As discussed above, the first user may view both the shared view of the image and the original view of the image on the display module 210.

The data source 214 and tools 216 on the first access device 202 facilitate user manipulation (e.g., panning, zooming, advanced processing, brightness, contrast, etc.), qualitative and/or quantitative annotation(s), dictation, editing and/or measuring of the shared view and/or the original view of the image via the first access device 202. This manipulation, annotation, dictation, editing and/or measuring by the first user and, more generally, content added to the shared view of the image may be conveyed to the second user and displayed using the display module 222 in real-time or substantially real-time. However, as discussed above, in some examples, the manipulation of the shared view of the image at the first access device 202 may be different than the manipulation of the shared view of the image at the second access device 204. In examples in which a plurality of images is shared, an image and/or view of that image at the first access device 202 may be different than an image and/or view of that image at the second access device 204. For example, the first user may select a first image of the plurality of shared images to view at the first access device 202 using the interface 212 and the second user may select a second image of the plurality of shared images to view at the second access device 204 using the interface 224.

The data source 226 and tools 228 of the second access device 204 facilitate user manipulation (e.g., panning, zooming, advanced processing, brightness, contrast, etc.), qualitative and/or quantitative annotation(s), editing, and/or measuring of the shared view of the image via the second access device 204. For example, if the second access device 204 is a mobile device having a graphical user interface, the second user can touch the user interface screen to annotate an item and/or region of interest (e.g., a bone fracture). The second user can perform multi-touch action on the user interface screen of the second access device 204 to request a distance measurement, for example. The second user can touch the user interface screen in conjunction with the activation of audio functionality to provide comments regarding the image being reviewed, for example.

This manipulation, annotation, editing and/or measuring by the second user and, more generally, content added to the shared view of the image may be conveyed to the first user and displayed using the display module 210 in real-time or substantially real-time. Additionally or alternatively, the first user may incorporate the annotation, editing and/or measuring received from the second user into the original view of the image by dragging this information into the original view of the image using the interface 212, for example. Additionally or alternatively, the information associated with the conference between the users can be saved at the first access device 202 and/or an external system for further use and/or later retrieval, for example. Using input (e.g., user input) received via the first access device 202 and/or the second access device 204 as well as information and functionality from the data sources 214 and/or 226 and the tools 216 and/or 228, the processor 218 can generate one or more reports.

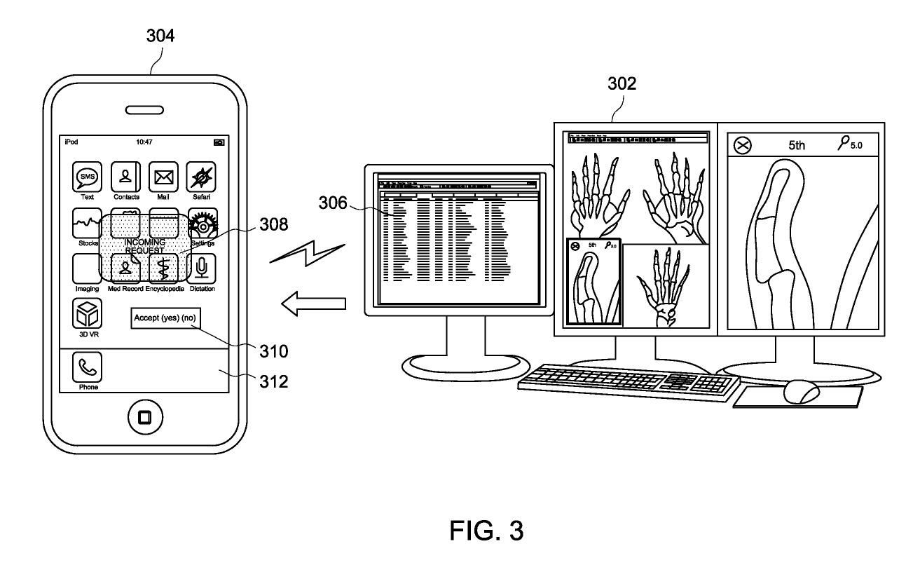

FIGS. 3-7 illustrate an example conferencing or image sharing application using a workstation (e.g., a first access device) 302 and a mobile device (e.g., a second access device) 304. Referring to FIG. 3, at 306, a first user may request a connection (e.g., request a conferencing and/or collaborating session) with a second user associated with the mobile device 304. The second user may be selected from a directory of users. The directory of users may include data associated with the respective user (e.g., contact information, curriculum vitae (CV), etc.). The directory of users may change depending on whether or not the respective user is logged into the associated conferencing system (e.g., the medical conferencing system 100 and/or 200), for example.

Once the request is initiated, at 308, the mobile device 304 receives an incoming request from the workstation 302. At 310, the second user may choose to accept or decline the request by touching a graphical user interface 312 of the mobile device 304, for example. The decision by the second user to accept or decline the request may be conveyed to the workstation 302. If the second user accepts the request, the connection between the workstation 302 and the mobile device 304 may be established and/or the session may be initiated, for example.

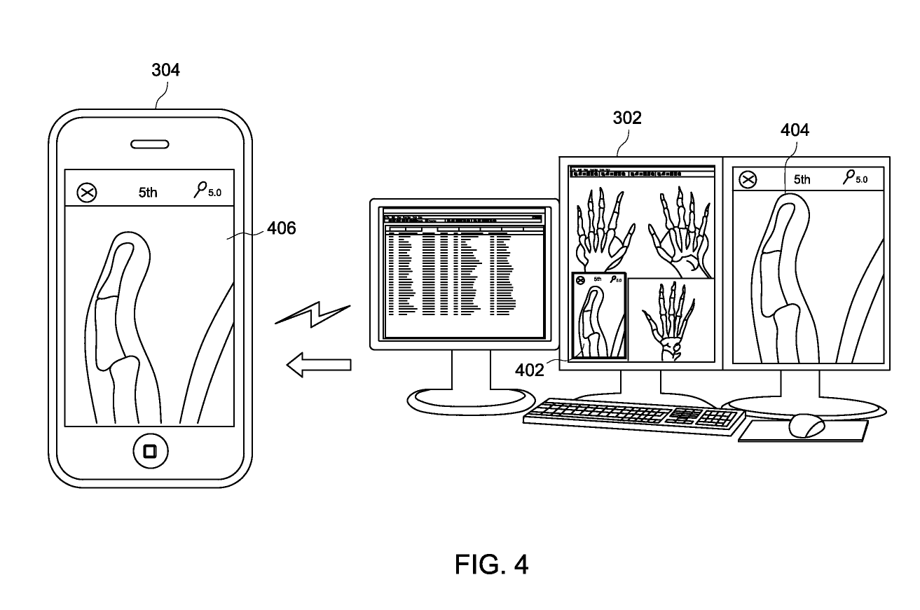

Referring to FIG. 4, if the second user accepts the request and the session has been initiated, at 402, the first user selects an image to share with the second user. Control is retained by the first user over an original view of the image (e.g., non-shared image) at 402 and a shared view of the image (e.g., shared view) may be displayed at 404. The first user may select the view of the shared image initially displayed at the mobile device 304. Once the shared view of the image is selected, the shared view of the image is displayed at 406 on the mobile device 304.

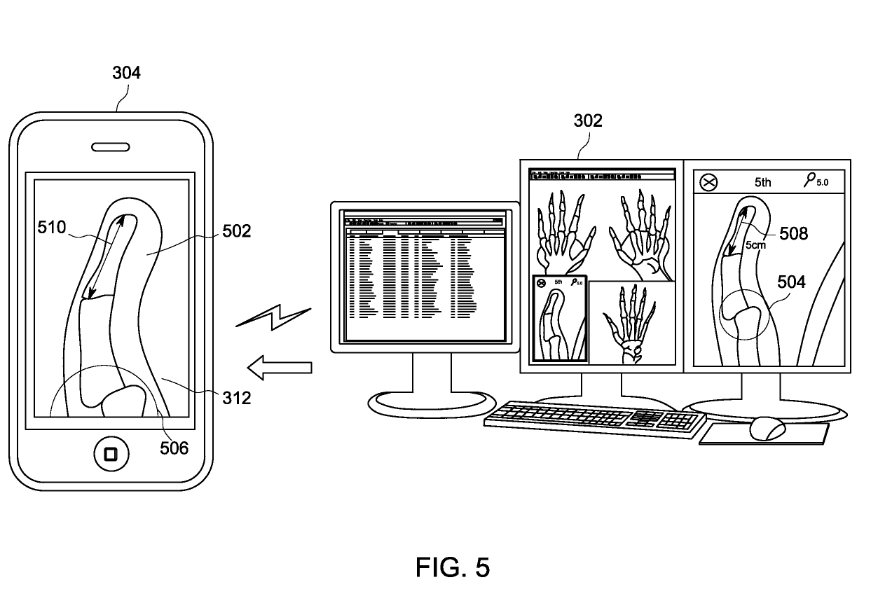

Referring to FIG. 5, the workstation 302 and the mobile device 304 may share the visualization parameters of the shared image, but the workstation 302 and the mobile device 304 may position the shared view of the image differently in the viewing area, the zoom may be different and/or the workstation 302 and the mobile device 304 may separately define annotation. For example, at 502, the second user may zoom and/or pan to a region of interest by touching the graphical user interface 312 of the mobile device 304 such that the shared view of the image at the mobile device 304 is different than the shared view of the image at the workstation 302.

At 504, the first user may enter a graphic object on the shared view of the image, which is then conveyed to the mobile device 304 at 506. At 508, the first user may enter a measurement on the shared view of the image, which is then conveyed to the mobile device 304 on the shared view of the image at 510. More generally, the parameter (e.g., the graphic object, the measurement, etc.) is transferred to the mobile device 304 and the parameters are registered to the shared view of the image at the mobile device 304, for example. Additionally or alternatively, at 506, the second user may enter a graphic object on the shared view of the image, which is then conveyed to the workstation 302 on the shared view of the image at 504. At 510, the second user may enter a measurement, which is then conveyed to the workstation 302 on the shared view of the image at 508.

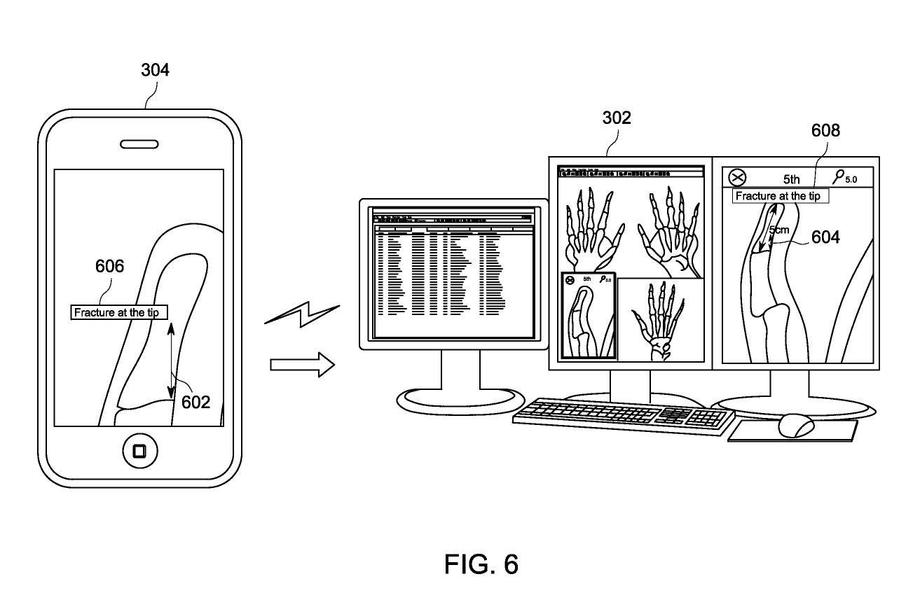

Referring to FIG. 6, at 602, the second user may enter context (e.g., annotation) on the shared view of the image, which is then conveyed to the workstation 302 on the shared view of the image at 604. At 606, the second user may enter a comment, which is then conveyed to the workstation 302 on the shared view of the image at 608. The shared view of the image at the workstation 302 may be viewed with first viewing parameters and the shared view of the image at the mobile device 304 may viewed with second viewing parameters different than the first viewing parameters; however, alternatively, the first and second viewing parameters may be the same or similar.

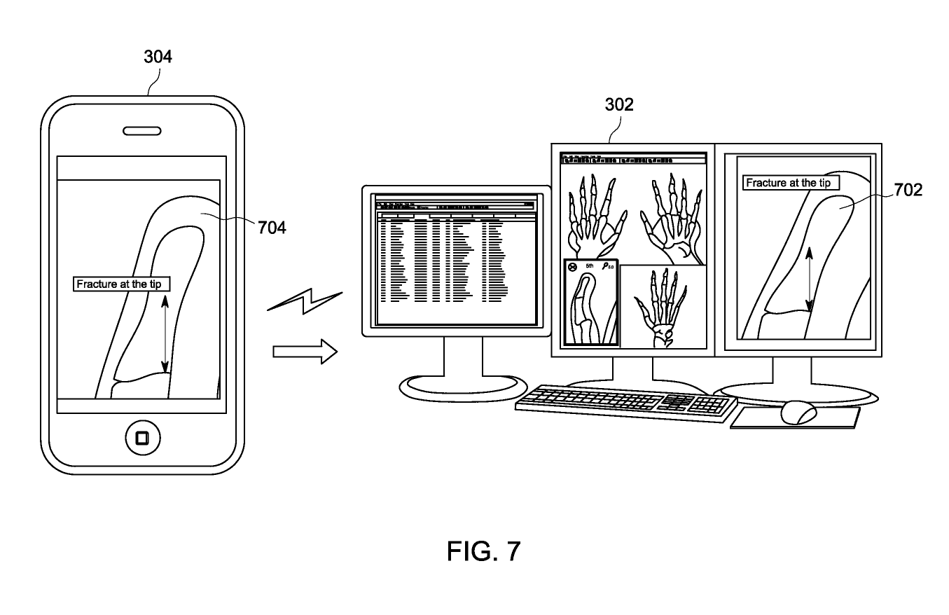

Referring to FIG. 7, the first user and/or the second user may initiate a mode using the workstation 302 and/or the mobile device 304 in which the viewing parameters of the shared view of the image are the same at both the workstation 302 and the mobile device 304, illustrated at 702 and 704, respectively.

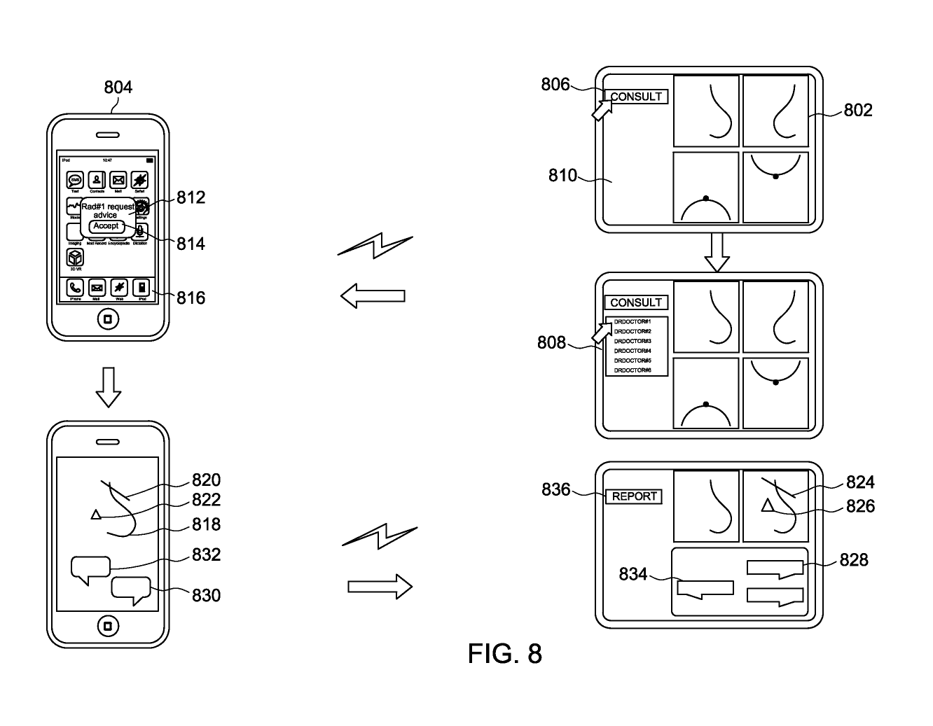

FIG. 8 illustrates an example conferencing or image sharing application using a first mobile device (e.g., iPad™, first access device) 802 and a second mobile device (e.g., iPhone™, second access device) 804. At 806, a first user associated with the first mobile device 802 may select consult to open a registry at 808 of doctors that may be available to participate in a session, for example. The user may open the registry by touching a graphical user interface 810 of the first mobile device 802. At 808, one of the doctors is selected from the registry and a request is then conveyed to the selected doctor.

At 812, the second mobile device 804 receives the incoming request from the first mobile device 802. At 814, a second user (e.g., the selected doctor) associated with the second mobile device 804 may choose to accept or decline the request by touching a graphical user interface 816 of the second mobile device 804, for example. The decision by the second user to accept or decline the request may be conveyed to the first mobile device 802. If the second user accepts the request, the connection between the first and second mobile devices 802 and 804 may be established and/or the session may be initiated, for example.

If the second user accepts the request and the session has been initiated, a shared image selected by the first user may be displayed at 818 on the second mobile device 804. At 820 and 822, the second user may mark an annotation on the shared view of the image, which is then conveyed to the shared view of the image at 824 and 826, respectively. The second user may change the image presentation of the shared view of the image at the second mobile device 804 and/or the first mobile device 802. At 828, the first user may enter a comment (e.g., voice, text message, etc.), which may be conveyed to the second mobile device 804 at 830. At 832, the second user may enter a comment (e.g., voice, text message, etc), which may be conveyed to the first mobile device 802 at 834. At 836, the first user may incorporate information (e.g., findings, conversation, etc.) associated with the session into a report and/or a report may be generated based on the information associated with the session, for example.

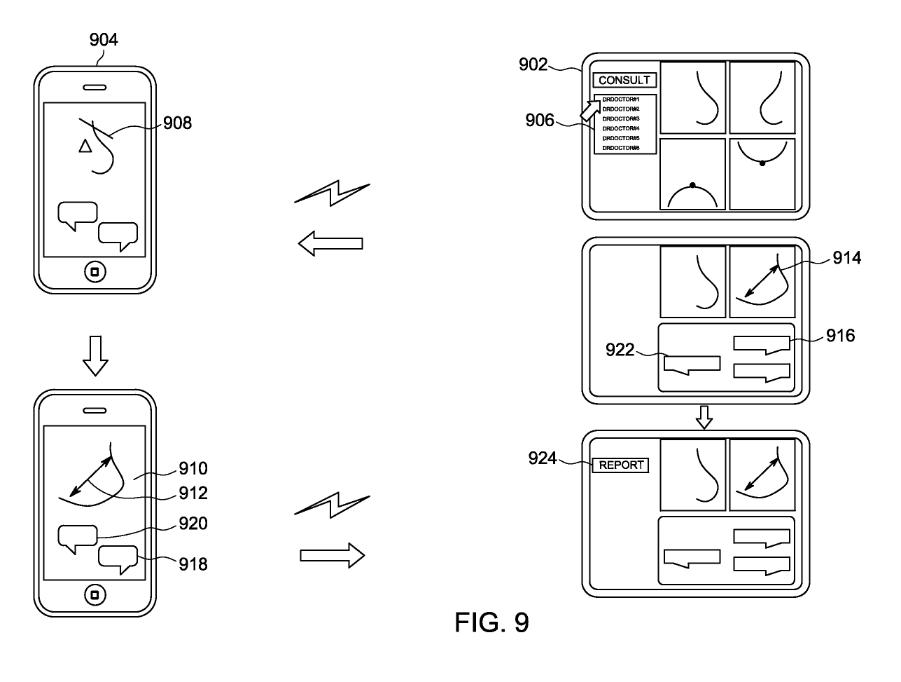

FIG. 9 illustrates an example conferencing or image sharing application using a first mobile device (e.g., iPad™, first access device) 902 and a second mobile device (e.g., iPhone™, second access device) 904. At 906, a first user associated with the first mobile device 902 may select a doctor from a registry. Once selected, a request may be conveyed to the corresponding doctor and that doctor may be prompted to accept or decline the request.

If the selected doctor accepts the request and a session has been initiated, a shared image selected by the first user may be displayed at 908 on the second mobile device 904. At 910, the second user (e.g., the selected doctor) may change the viewing parameters (e.g., zoom, pan, rotate, etc.) of the shared view of the image; however, changes to the viewing parameters of the shared view of the image at the second mobile device 904 may not affect the viewing parameters of the shared view of the image at the first mobile device 902.

At 912, the second user may perform a measurement on the shared view of the image, which is then conveyed to the shared view of the image at 914. At 916, the first user may enter a comment (e.g., voice, text message, etc.), which may be conveyed to the second mobile device 904 at 918. At 920, the second user may enter a comment (e.g., voice, text message, etc), which may be conveyed to the first mobile device 902 at 922. At 924, the first user may incorporate information (e.g., findings, conversation, etc.) associated with the session into a report and/or a report may be generated based on the information associated with the session, for example.

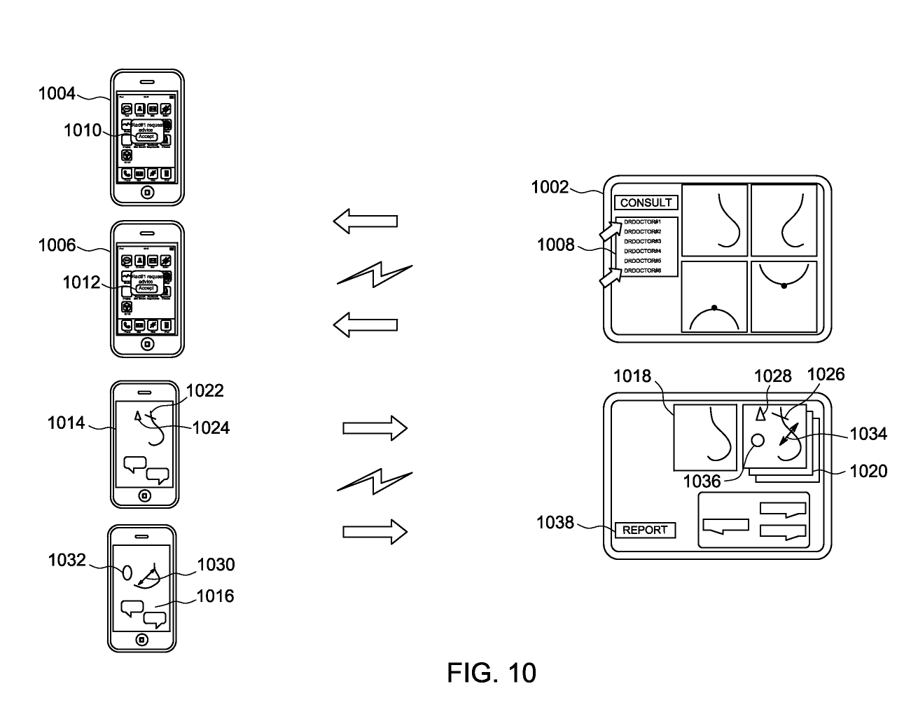

FIG. 10 illustrates an example conferencing or image sharing application using a first mobile device (e.g., iPad™, first access device) 1002, a second mobile device (e.g., iPhone™, second access device) 1004 and a third mobile device (e.g., iPhone™, third access device) 1006. At 1008, a first user associated with the first mobile device 1002 may select a plurality of doctors from a registry and requests may then be conveyed to the selected doctors at 1010 and 1012. A second user (e.g., selected doctor) associated with the second mobile device 1004 and a third user (e.g., selected doctor) associated with the third mobile device 1006 may choose to accept or decline the respective request. If the second and third users accept the requests, the connection between the first and second mobile devices 1002 and 1004 and between the first and third mobile devices 1002 and 1006 may be established and/or the session(s) may be initiated, for example.

A shared image selected by the first user may be displayed at 1014 on the second mobile device 1004 and at 1016 on the third mobile device 1006. At 1018, an original view of the image is displayed (e.g., non-shared image), which the first user retains control over. At 1020, a plurality of shared views of the image is displayed (e.g., shared image). Some of the plurality of images at 1020 corresponds to a shared view of the image at the respective second and third mobile devices 1004 and 1006 and another one of the plurality of images at 1020 corresponds to an image that incorporates the edits (e.g., qualitative and/or quantitative annotation(s), editing, measuring, etc.) made at the second and third mobile devices 1004 and 1006. In some examples, by selecting the shared image associated with the second user at the first mobile device 1002, the first mobile device 1002 may display that image and any corresponding conversation (e.g., dialogue) between the first and second users. In some examples, by selecting the shared image that incorporates the edits of both the second and third mobile devices 1004 and 1006, the first mobile device 1002 may display the edits and any corresponding conversation between the first user and the second user and between the first user and the third user.

At 1022 and 1024, the second user may mark an annotation on the shared view of the image, which is then conveyed to the shared view (e.g., image that incorporates the edits of both the second and third mobile devices 1004 and 1006) of the image at 1026 and 1028. At 1030 and 1032, the third user may mark an annotation on the shared view of the image, which is then conveyed to the shared view of the image at 1034 and 1036. At 1038, the first user may incorporate information (e.g., findings, conversation, etc.) associated with the session into a report and/or a report may be generated based on the information associated with the session, for example.

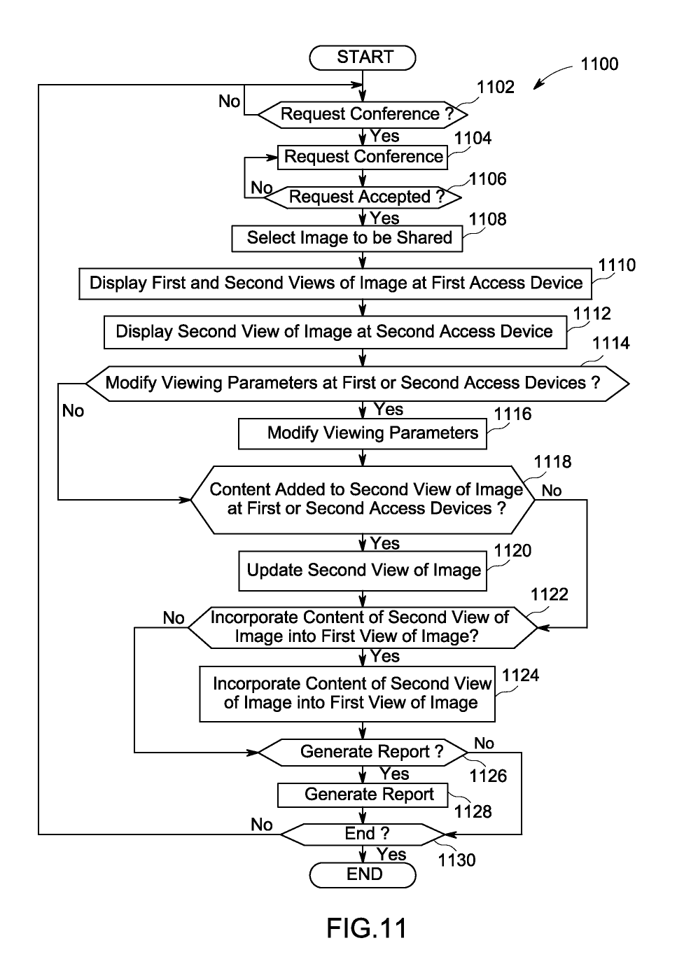

FIG. 11 depicts an example flow diagram representative of processes that may be implemented using, for example, computer readable instructions that may be used to facilitate medical conferencing using a plurality of access devices. The example processes of FIG. 1 may be performed using a processor, a controller and/or any other suitable processing device. For example, the example processes of FIG. 11 may be implemented using coded instructions (e.g., computer readable instructions) stored on a tangible computer readable medium such as a flash memory, a read-only memory (ROM), and/or a random-access memory (RAM). As used herein, the term tangible computer readable medium is expressly defined to include any type of computer readable storage and to exclude propagating signals. Additionally or alternatively, the example processes of FIG. 11 may be implemented using coded instructions (e.g., computer readable instructions) stored on a non-transitory computer readable medium such as a flash memory, a read-only memory (ROM), a random-access memory (RAM), a cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

Alternatively, some or all of the example processes of FIG. 11 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIG. 11 may be implemented manually or as any combination(s) of any of the foregoing techniques, for example, any combination of firmware, software, discrete logic and/or hardware. Further, although the example processes of FIG. 11 are described with reference to the flow diagram of FIG. 11, other methods of implementing the processes of FIG. 11 may be employed. For example, the order of execution of the blocks may be changed, and/or some of the blocks described may be changed, eliminated, sub-divided, or combined. Additionally, any or all of the example processes of FIG. 11 may be performed sequentially and/or in parallel by, for example, separate processing threads, processors, devices, discrete logic, circuits, etc.

Referring to FIG. 11, at 1102, a method 1100 determines if a conference has been requested. If a conference has been requested control advances to block 1104. At 1104, a conference is requested. For example, if a first user associated with a first access device requests a session and/or conference with a second user associated with a second access device, a request may be conveyed to the second access device. At 1106, the method 1100 determines whether not the second user accepted the request. If the second user declines the conference request, control advances to block 1104 and another conference request may be initiated.

However, if the second user accepts the request, control advances to block 1108 and the first user may select an image to be shared with the second user. At 1110, a first view of the image (e.g., a non-shared view) and a second view of the image (e.g., a shared view) may be displayed at the first access device. At 1112, the second view of the image (e.g., a shared view) may be displayed at the second access device.

At 1114, the method 1100 determines whether or not to modify viewing parameters of the second view of the image at the first access device or the second access device and, at 1116, the viewing parameters can be modified. The viewing parameters may include panning, zooming, advanced processing, brightness, contrast and may be modified by the first user at the first access device or the second user at the second access device. The viewing parameters of the second view of the image at the first access device may the same or different than the viewing parameters of the second view of the image at the second access device based on user input, for example.

At 1118, the method 1100 determines if content (e.g., qualitative and/or quantitative annotation(s), dictation, editing and/or measuring, etc.) has been added to the second view of the image at the first access device or the second access device. If content has been added, control advances to block 1120 and the second view of the image can be updated. In some examples, if the second user at the second access device adds an annotation to the second view of the image, the second view of the image at the first access device can be updated to include the annotation. In some examples, if the first user at the first access device adds an annotation to the second view of the image, the second view of the image at the second access device can be updated to include the annotation.

At 1122, the method 1100 determines if content of the second view of the image is to be incorporated into the first view of the image and, at 1124, this information can be incorporated into the first view of the image. For example, the first user may incorporate the content (e.g., annotation, editing and/or measuring, etc.) into the first view of the image by dragging this information into the first view of the image.

At 1126, the method 110 determines if a report is to be generated and, at 1128, a report can be generated. For example, a report can be generated using information associated with the conference. At 1130, the method 1100 determines whether or not to request another conference. Otherwise the example method 1100 is ended.

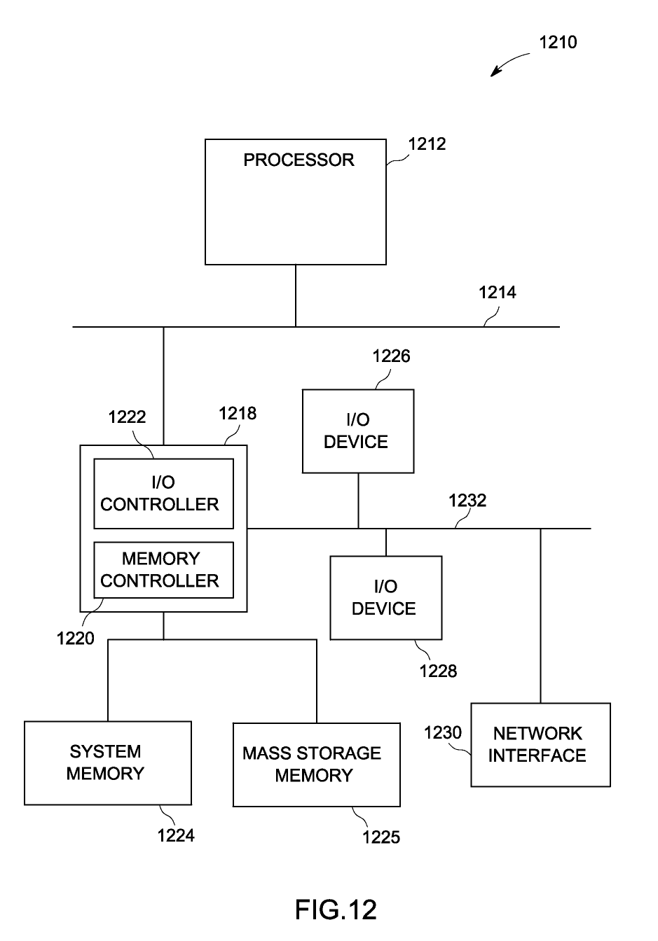

FIG. 12 is a block diagram of an example processor system 1210 that may be used to implement the apparatus and methods described herein. As shown in FIG. 12, the processor system 1210 includes a processor 1212 that is coupled to an interconnection bus 1214. The processor 1212 may be any suitable processor, processing unit or microprocessor. Although not shown in FIG. 12, the system 1210 may be a multi-processor system and, thus, may include one or more additional processors that are identical or similar to the processor 1212 and that are communicatively coupled to the interconnection bus 1214.

The processor 1212 of FIG. 12 is coupled to a chipset 1218, which includes a memory controller 1220 and an input/output (I/O) controller 1222. As is well known, a chipset typically provides I/O and memory management functions as well as a plurality of general purpose and/or special purpose registers, timers, etc. that are accessible or used by one or more processors coupled to the chipset 1218. The memory controller 1220 performs functions that enable the processor 1212 (or processors if there are multiple processors) to access a system memory 1224 and a mass storage memory 1225.

The system memory 1224 may include any desired type of volatile and/or non-volatile memory such as, for example, static random access memory (SRAM), dynamic random access memory (DRAM), flash memory, read-only memory (ROM), etc. The mass storage memory 1225 may include any desired type of mass storage device including hard disk drives, optical drives, tape storage devices, etc.

The I/O controller 1222 performs functions that enable the processor 1212 to communicate with peripheral input/output (I/O) devices 1226 and 1228 and a network interface 1230 via an I/O bus 1232. The I/O devices 1226 and 1228 may be any desired type of I/O device such as, for example, a keyboard, a video display or monitor, a mouse, etc. The network interface 1230 may be, for example, an Ethernet device, an asynchronous transfer mode (ATM) device, an 802.11 device, a DSL modem, a cable modem, a cellular modem, etc. that enables the processor system 1210 to communicate with another processor system.

While the memory controller 1220 and the I/O controller 1222 are depicted in FIG. 12 as separate blocks within the chipset 1218, the functions performed by these blocks may be integrated within a single semiconductor circuit or may be implemented using two or more separate integrated circuits.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

1. A method of conferencing including sharing medical images and information between a first access device and a second access device, comprising:
enabling a first user associated with the first access device to request a conference with a second user associated with the second access device;
determining acceptance by the second user of the conference;
enabling the conference to be initiated between the first access device and the second access device;
enabling the first user to select at least one image to be displayed at the second access device;
displaying a first view of the image and a second view of the image at the first access device;
displaying the second view of the image at second access device;
enabling the first access device to retain control over the first view of the image; and
enabling the first user at the first access device and the second user at the second access device to substantially simultaneously add content to the second view of the image.

2. The method of claim 1, further comprising enabling the second view of the image at the first access device to comprise first viewing parameters and the second view of the image at the second access device to comprise second viewing parameters different than the first viewing parameters.

3. The method of claim 1, further comprising dynamically updating viewing parameters of the second view of the image at the first access device based on viewing parameters of the second view of the image at the second access device.

4. The method of claim 1, further comprising dynamically updating viewing parameters of the second view of the image at the second access device based on viewing parameters of the second view of the image at the first access device.

5. The method of claim 1, further comprising dynamically updating the second view of the image at the first access device based on content added to the second view of the image at the second access device.

6. The method of claim 1, further comprising dynamically updating the second view of the image at the second access device based on content added to the second view of the image at the first access device.

7. The method of claim 1, further comprising enabling the first user at the first access device to incorporate content from the second view of image into the first view of the image.

8. The method of claim 1, further comprising facilitating dialogue between the users at the first access device and the second access device.

9. The method of claim 1, further comprising automatically incorporating results associated with the conference into a medical report.

10. The method of claim 1, wherein adding content to the second view of the image comprises drawing shapes and annotating to generate measurements, highlight abnormal structure, and add textual comments to the second view of the image.

11. The method of claim 1, wherein the first access device comprises a workstation and the second access device comprises a mobile device.

12. The method of claim 1, further comprising enabling the first user to select viewing parameters of the second view of the image at the second access device.

13. A method of sharing digital radiology images between a workstation and a mobile device, comprising:
enabling a first user associated with the workstation to request a conference with a second user associated with the mobile device;
determining acceptance by the second user of the conference;
enabling the conference to be initiated between the workstation and the mobile device;
enabling the first user to select at least one image to be shared with the second user;
displaying a first view of the image and a second view of the image at the workstation;
displaying the second view of the image at the mobile device;
enabling the second view of the image at the workstation to comprise first viewing parameters and the second view of the image at the mobile device to comprise second viewing parameters different than the first viewing parameters; and
enabling the first user at the workstation and the second user at the mobile device to add content to the second view of the image.

14. The method of claim 13, further comprising enabling the first user at the workstation to incorporate content from the second view of image into the first view of the image.

15. The method of claim 13, further comprising facilitating dialogue between the users at the workstation and the mobile device.

16. The method of claim 13, wherein adding content to the second view of the image comprises drawing shapes and annotating to generate measurements, highlight abnormal structure, and add textual comments to the second view of the image.

17. A medical conferencing system, comprising:
an access device and a mobile device, the mobile device comprising:
a first data storage to store data including a shared image received from the access device;
a first user interface to display the shared image for user viewing, manipulation, annotation, and measuring, the manipulation enabling the shared image to be displayed at the mobile device with different viewing parameters than at the access device; and
a first processor to receive input via the first user interface and provide content, including the shared image to the first user interface, the processor to receive input via the access device and provide content to the first user interface, the processor to convey input received via the first user interface to the access device.

18. The medical conferencing system of claim 17, wherein the access device comprises:
an initiator to initiate a conference with the mobile device;
a second data storage to store data including the shared image to be displayed at the mobile device and a non-shared image to which control is retained by the access device;
a second user interface to display the shared image and the non-shared image for user viewing and manipulation; and
a second processor to receive input via the second user interface and provide content, including the shared image and the non-shared image to the second user interface, the second processor to receive input via the mobile device and provide content to the second user interface, the processor to convey input received via the second user interface to the mobile device.

19. The medical conferencing system of claim 18, wherein the first and second user interfaces and the first and second processors enable content to be added to the shared image and the content to be dynamically displayed at both the access device and the mobile device via the respective first and second user interfaces.

20. The medical conferencing system of claim 18, wherein the user interface comprises a touch screen.

21. The medical conferencing system of claim 18, wherein the access device comprises a workstation.
